(19) United States
(12) Patent Application Publication
(10) Pub. No.: US 2024/0291615 A1
(43) Pub. Date: Aug. 29, 2024

(54) METHOD FOR ADJUSTING SOUNDING REFERENCE SIGNAL (SRS) RESOURCE, AND APPARATUS THEREFOR

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/694,570

(22) PCT Filed: Sep. 29, 2021
(86) PCT No.: PCT/CN2021/121960

§ 371 Date: Mar. 22, 2024

(51) Int. Cl. H04L 5/00; H04B 7/06

(52) U.S. Cl. CPC H04L 5/0051; H04B 7/0626

(57) ABSTRACT

Disclosed in the embodiments of the present application are a method for adjusting a sounding reference signal (SRS) resource, and an apparatus therefor, which can be applied to systems such as a long term evolution (LTE) system, a 5th generation (5G) mobile communication system, a 5G new radio (NR) system, or other future new mobile communication systems. The method comprises: a terminal device determines an SRS resource configuration adjustment condition according to target information; and the terminal device sends to a network-side device SRS resource configuration update information expected by the terminal device. The network-side device receives the SRS resource configuration update information expected by the terminal device that is sent by the terminal device; and, according to the SRS resource configuration update information expected by the terminal device, the network-side device adjusts the SRS resource configuration corresponding to the terminal device. By implementing the embodiments of the present application, the SRS resource configuration update information expected by a terminal device is determined by means of target information, such that the problem of an SRS set configuration not adapting to the capabilities of the terminal device and to a change in a channel or a change in interference can be avoided, thereby being conducive to saving resources and avoiding resource waste.

### TECHNICAL FIELD

The present application relates to the field of communication technologies, and in particular, to a method and apparatus for adjusting an SRS resource.

### BACKGROUND

In wireless communication, the uplink sounding reference signal (SRS) may be a periodic SRS, a Semi-Persistent Scheduling (SPS) SRS or an aperiodic (AP) SRS, may be a narrowband SRS or a wideband SRS, may be a single-port SRS or a multi-port SRS. The network side may configure a plurality of uplink SRS sets for the terminal device, and one resource set includes one or more SRS resources. One SRS resource may be on several consecutive Orthogonal Frequency Division Multiplexing (OFDM) symbols.

Codebook-based or non-codebook-based transmission can be used to obtain uplink Channel State Information (CSI) through configuration of SRS. The SRS resource set is associated with different Transmission Reception Points (TRPs), and is configured for the terminal through the Radio Resource Control (RRC) signaling. The terminal needs to configure at most one SRS resource set for codebook-based uplink transmission. The SRS resource set may be configured with a plurality of SRS resources. The network side may feed back an SRS Resource Indicator (SRI), and the SRS resource is selected through the SRI indicator.

In the related art, in order to avoid RRC reconfiguration as much as possible, the largest SRS set is generally selected and configured for the terminal, which causes a large signaling overhead and cannot well adapt to the terminal capability, the change of channel or the change of interference. Meanwhile, as the number of antenna panels increases, the problems of flexibility and signaling overhead will become more prominent.

### SUMMARY

Embodiments of the present application provide a method and apparatus for adjusting a sounding reference signal (SRS) resource, which can be applied to a long term evolution (LTE) system, a fifth generation (5th generation, 5G) mobile communication system, a 5G new radio (NR) system, or other future new mobile communication systems, etc. By determining the SRS resource configuration update information expected by the terminal device through the target information, it can be prevented that the SRS set configuration does not adapt to the capability of the terminal device and the change of the channel or the change of the interference, thereby saving resources and avoiding waste of resources.

In the first aspect, an embodiment of the present application provides a method for adjusting an SRS resource, which is applied to a terminal device, and the method includes:
determining an SRS resource configuration adjustment condition according to target information; and
sending SRS resource configuration update information expected by the terminal device to a network-side device.

By implementing the embodiments of the present application, it is possible to determine the SRS resource configuration update information expected by the terminal device through the target information. In this way, it is possible to prevent the SRS set configuration from not adapting to the capability of the terminal device and the change of the channel or the change of the interference, thereby helping to avoid waste of resources.

Optionally, the terminal device includes at least one antenna panel (Panel), and the target information includes at least one of the following:
measurement information of channel state information (CSI) of the at least one Panel;
measurement information of a beam management of the at least one Panel; or
change information of an antenna use state of the at least one Panel.

Optionally, each Panel in the terminal device corresponds to at least one SRS resource set, and each of the SRS resource sets includes at least one SRS resource.

Optionally, the SRS resource configuration update information includes one or more of the following:
an activation state of an expected SRS resource set on a target Panel;
an activation state of a target SRS resource in the expected SRS resource set on the target Panel.

Optionally, the target Panel is one of the following:
all Panels on the terminal device;
a Panel on the terminal device that has a channel state change meeting the SRS resource adjustment condition;
a specific Panel on the terminal device.

By implementing the embodiments of the present application, it is possible to determine the SRS resource configuration update information expected by the terminal device through the target Panel. In this way, it is possible to prevent the SRS set configuration from not adapting to the capabilities of some or all Panels on the terminal device, and the change of channel or the change of interference, thereby helping to avoid resource waste and improve beam transmission quality.

Optionally, the target SRS resource is all SRS resources or a specific SRS resource in a corresponding SRS resource set.

Optionally, the SRS resource configuration update information expected by the terminal device is carried by a radio resource control (RRC) signaling, a media access control-control element (MAC-CE) signaling or uplink control information (UCI).

By implementing the embodiments of the present application, the SRS resource configuration update information expected by the terminal device can be reported via the radio resource control (RRC) signaling, the medium access control-control element (MAC-CE) signaling or the uplink control information (UCI). In this way, it is possible to prevent the SRS set configuration from not adapting to the capability of the terminal device and the change of the channel or the change of the interference, thereby helping to avoid waste of resources and improve beam transmission quality.

Optionally, the SRS resource configuration update information includes one of following items:
a first Bitmap, where the SRS resource configuration update information of each Panel is independently indicated in the first Bitmap, and the SRS configuration update information of a plurality of Panels are indicated sequentially;
a second Bitmap, where the SRS resource configuration update information of all Panels is jointly indicated through the second Bitmap;
a first Codepoint, where the first Codepoint indicates the SRS resource configuration update information of each Panel correspondingly and independently, and indicates the SRS configuration update information of a plurality of Panels sequentially;
a second Codepoint, where the SRS resource configuration update information of all Panels is jointly indicated through the second Codepoint.

Optionally, the method further includes:
sending one or more of an ID of an SRS resource set and an ID of a target Panel to the network-side device.

Optionally, in response to that the SRS resource configuration update information expected by the terminal device is carried by the UCI signaling, the method includes one of the following:
sending the SRS resource configuration update information through a channel state information (CSI) report quantity;
reporting through a periodic CSI configuration measurement;
reporting through a semi-static CSI configuration measurement;
reporting through an aperiodic CSI configuration measurement.

Optionally, the SRS resource is used for codebook transmission or non-codebook transmission, and the SRS resource is one of the following:
a periodic P-SRS resource;
a semi-static SP-SRS resource;
an aperiodic AP-SRS resource.

In a second aspect, the embodiment of the present application provides another method for adjusting an SRS resource, the method including:
receiving SRS resource configuration update information expected by a terminal device sent by the terminal device; and
adjusting an SRS resource configuration corresponding to the terminal device according to the SRS resource configuration update information expected by the terminal device.

By implementing the embodiments of the present application, it is possible to adjust the SRS resource configuration corresponding to the terminal device through the SRS resource configuration update information expected by the terminal device. In this way, it is possible to prevent the SRS set configuration from not adapting to the capability of the terminal device and the change of the channel or the change of the interference, thereby helping to avoid waste of resources.

Optionally, the terminal device includes at least one antenna panel (Panel), each antenna panel (Panel) in the terminal device corresponds to at least one SRS resource set, and each of the SRS resource sets includes at least one SRS resource.

Optionally, the SRS resource configuration update information includes one or more of the following:
an activation state of an expected SRS resource set on a target Panel;
an activation state of a target SRS resource in the expected SRS resource set on the target Panel.

Optionally, the target Panel is one of the following:
all Panels on the terminal device;
a Panel on the terminal device that has a channel state change meeting an SRS resource adjustment condition;
a specific Panel on the terminal device.

By implementing the embodiments of the present application, it is possible to determine the SRS resource configuration update information expected by the terminal device through the target Panel. In this way, it is possible to prevent the SRS set configuration from not adapting to the capabilities of some or all Panels on the terminal device, and the change of channel or the change of interference, thereby helping to avoid resource waste and improve beam transmission quality.

Optionally, the target SRS resource is all SRS resources or a specific SRS resource in a corresponding SRS resource set.

Optionally, the SRS resource configuration update information is carried by a radio resource control (RRC) signaling, a medium access control-control element (MAC-CE) signaling or uplink control information (UCI).

By implementing the embodiments of the present application, the SRS resource configuration update information expected by the terminal device can be received through the radio resource control (RRC) signaling, the medium access control-control element (MAC-CE) signaling or the uplink control information (UCI). In this way, it is possible to prevent the SRS set configuration from not adapting to the capability of the terminal device and the change of the channel or the change of the interference, thereby helping to avoid waste of resources and improve beam transmission quality.

Optionally, the SRS resource configuration update information includes one of following items:
a first Bitmap, where the SRS resource configuration update information of each Panel is independently indicated in the first Bitmap, and the SRS configuration update information of a plurality of Panels are indicated sequentially;
a second Bitmap, where the SRS resource configuration update information of all Panels is jointly indicated through the second Bitmap;
a first Codepoint, where the first Codepoint indicates the SRS resource configuration update information of each Panel correspondingly and independently, and indicates the SRS configuration update information of a plurality of Panels sequentially;
a second Codepoint, where the SRS resource configuration update information of all Panels is jointly indicated through the second Codepoint.

Optionally, the method further includes:
receiving one or more of an ID of an SRS resource set and an ID of a target Panel sent by the terminal device.

Optionally, in response to that the SRS resource configuration update information expected by the terminal device is carried by the UCI signaling, the method includes one of the following:
receiving the SRS resource configuration update information through a channel state information (CSI) report quantity;
receiving through a periodic CSI configuration measurement;
receiving through a semi-static CSI configuration measurement;
receiving through an aperiodic CSI configuration measurement.

Optionally, the SRS resource is used for codebook transmission or non-codebook transmission, and the SRS resource is one of the following:
a periodic P-SRS resource;
a semi-static SP-SRS resource;
an aperiodic AP-SRS resource.

Optionally, adjusting the SRS resource configuration corresponding to the terminal device according to the SRS resource configuration update information expected by the terminal device includes:
generating a corresponding SRS resource indicator (SRI) according to the SRS resource configuration update information;
sending the SRI to the terminal device.

In the third aspect, the embodiment of the present application provides a communication apparatus, which has some or all functions of the terminal device in the method described in the first aspect above, for example, the functions of the communication device may have the functions of part or all of the embodiments in the present application, or may have the function of independently implementing any one of the embodiments in the present application. The functions described above may be implemented by hardware, or may be implemented by executing corresponding software on the hardware. The hardware or software includes one or more units or modules corresponding to the above functions.

In an implementation manner, the structure of the communication apparatus may include a transceiver module and a processing module, and the processing module is configured to support the communication apparatus to perform corresponding functions in the foregoing method. The transceiver module is configured to support communication between the communication apparatus and other device(s). The communication apparatus may further include a storage module, which is configured to be coupled with the transceiver module and the processing module, and store necessary computer programs and data of the communication apparatus.

As an example, the processing module may be a processor, the transceiver module may be a transceiver or a communication interface, and the storage module may be a memory.

In an implementation manner, the communication apparatus includes:
a determining module, configured to determine an SRS resource configuration adjustment condition according to target information;
a sending module, configured to send SRS resource configuration update information expected by the terminal device to a network-side device.

Optionally, the terminal device includes at least one antenna panel (Panel), and the target information includes at least one of the following:
measurement information of channel state information (CSI) of the at least one Panel;
measurement information of a beam management of the at least one Panel; or
change information of an antenna use state of the at least one Panel.

Optionally, each Panel in the terminal device corresponds to at least one SRS resource set, and each of the SRS resource sets includes at least one SRS resource.

Optionally, the SRS resource configuration update information includes one or more of the following:
an activation state of an expected SRS resource set on a target Panel;
an activation state of a target SRS resource in the expected SRS resource set on the target Panel.

Optionally, the target Panel is one of the following: all Panels on the terminal device;
a Panel on the terminal device that has a channel state change meeting the SRS
resource adjustment condition;
a specific Panel on the terminal device.

Optionally, the target SRS resource is all SRS resources or a specific SRS resource in a corresponding SRS resource set.

Optionally, the SRS resource configuration update information expected by the terminal device is carried by a radio resource control (RRC) signaling, a media access control-control element (MAC-CE) signaling or uplink control information (UCI).

Optionally, the SRS resource configuration update information includes one of following items:
a first Bitmap, wherein the SRS resource configuration update information of each Panel is independently indicated in the first Bitmap, and the SRS configuration update information of a plurality of Panels are indicated sequentially;
a second Bitmap, wherein the SRS resource configuration update information of all Panels is jointly indicated through the second Bitmap;
a first Codepoint, wherein the first Codepoint indicates the SRS resource configuration update information of each Panel correspondingly and independently, and indicates the SRS configuration update information of a plurality of Panels sequentially;
a second Codepoint, wherein the SRS resource configuration update information of all Panels is jointly indicated through the second Codepoint.

Optionally, the apparatus further includes:
a first sending submodule, configured to send one or more of an ID of an SRS resource set and an ID of a target Panel to the network-side device.

Optionally, in response to that the SRS resource configuration update information expected by the terminal device is carried by the UCI signaling, the method includes one of the following:
a second sending submodule, configured to send the SRS resource configuration update information through a channel state information (CSI) report quantity;
a third sending submodule, configured to report through a periodic CSI configuration measurement;
a fourth sending submodule, configured to report through a semi-static CSI configuration measurement;
a fifth sending submodule, configured to report through an aperiodic CSI configuration measurement.

Optionally, the SRS resource is used for codebook transmission or non-codebook transmission, and the SRS resource is one of the following:
a periodic P-SRS resource;
a semi-static SP-SRS resource;
an aperiodic AP-SRS resource.

In the fourth aspect, the embodiment of the present application provides another communication apparatus, which can implement some or all of the functions of the network device in the method example described in the second aspect above, for example, the functions of the communication apparatus may have the functions of part or all of the embodiments in the present application, or may have the function of independently implementing any one of the embodiments in the present application. The functions described above may be implemented by hardware, or may be implemented by executing corresponding software on the hardware. The hardware or software includes one or more units or modules corresponding to the above functions.

In an implementation manner, the structure of the communication apparatus may include a transceiver module and a processing module, and the processing module is configured to support the communication apparatus to perform corresponding functions in the foregoing method. The transceiver module is configured to support communication between the communication apparatus and other device(s). The communication apparatus may further include a storage module, which is configured to be coupled with the transceiver module and the processing module, and store necessary computer programs and data of the communication apparatus.

As an example, the processing module may be a processor, the transceiver module may be a transceiver or a communication interface, and the storage module may be a memory.

In an implementation manner, the communication apparatus includes:
a receiving module, configured to receive SRS resource configuration update information expected by a terminal device sent by the terminal device; and
an adjustment module, configured to adjust an SRS resource configuration corresponding to the terminal device according to the SRS resource configuration update information expected by the terminal device.

Optionally, the terminal device includes at least one antenna panel (Panel), each antenna panel (Panel) in the terminal device corresponds to at least one SRS resource set, and each of the SRS resource sets includes at least one SRS resource.

Optionally, the SRS resource configuration update information includes one or more of the following:
an activation state of an expected SRS resource set on a target Panel;
an activation state of a target SRS resource in the expected SRS resource set on the target Panel.

Optionally, the target Panel is one of the following:
all Panels on the terminal device;
a Panel on the terminal device that has a channel state change meeting an SRS resource adjustment condition;
a specific Panel on the terminal device.

Optionally, the target SRS resource is all SRS resources or a specific SRS resource in a corresponding SRS resource set.

Optionally, the SRS resource configuration update information is carried by a radio resource control (RRC) signaling, a medium access control-control element (MAC-CE) signaling or uplink control information (UCI).

Optionally, the SRS resource configuration update information includes one of following items:
a first Bitmap, where the SRS resource configuration update information of each Panel is independently indicated in the first Bitmap, and the SRS configuration update information of a plurality of Panels are indicated sequentially;
a second Bitmap, where the SRS resource configuration update information of all Panels is jointly indicated through the second Bitmap;
a first Codepoint, where the first Codepoint indicates the SRS resource configuration update information of each Panel correspondingly and independently, and indicates the SRS configuration update information of a plurality of Panels sequentially;
a second Codepoint, where the SRS resource configuration update information of all Panels is jointly indicated through the second Codepoint.

Optionally, the apparatus further includes:
a first receiving submodule, configured to receive one or more of an ID of an SRS resource set and an ID of a target Panel sent by the terminal device.

Optionally, in response to that the SRS resource configuration update information expected by the terminal device is carried by the UCI signaling, the method includes one of the following:
a second receiving submodule, configured to receive the SRS resource configuration update information through a channel state information (CSI) report quantity;
a third receiving submodule, configured to receive through a periodic CSI configuration measurement;
a fourth receiving submodule, configured to receive through a semi-static CSI configuration measurement;
a fifth receiving submodule, configured to receive through an aperiodic CSI configuration measurement.

Optionally, the SRS resource is used for codebook transmission or non-codebook transmission, and the SRS resource is one of the following:
a periodic P-SRS resource;
a semi-static SP-SRS resource;
an aperiodic AP-SRS resource.

Optionally, the adjustment module includes:
a generating submodule, configured to generate a corresponding SRS resource indicator (SRI) according to the SRS resource configuration update information;
a sending submodule, configured to send the SRI to the terminal device.

In a fifth aspect, an embodiment of the present application provides a communication apparatus, where the communication apparatus includes a processor, and when the processor invokes a computer program in a memory, it executes the method described in the first aspect above.

In a sixth aspect, an embodiment of the present application provides a communication apparatus, where the communication device includes a processor, and when the processor invokes a computer program in a memory, it executes the method described in the second aspect above.

In the seventh aspect, an embodiment of the present application provides a communication apparatus, the communication device includes a processor and a memory, and a computer program is stored in the memory; the processor executes the computer program stored in the memory, so that the communication apparatus executes the method described in the first aspect above.

In an eighth aspect, an embodiment of the present application provides a communication apparatus, the communication apparatus includes a processor and a memory, and a computer program is stored in the memory; the processor executes the computer program stored in the memory, so that the communication device executes the method described in the second aspect above.

In the ninth aspect, an embodiment of the present application provides a communication apparatus, the apparatus includes a processor and an interface circuit, the interface circuit is configured to receive code instructions and transmit them to the processor, and the processor is configured to run the code instructions to make the apparatus execute the method described in the first aspect above.

In the tenth aspect, an embodiment of the present application provides a communication apparatus, the apparatus includes a processor and an interface circuit, the interface circuit is configured to receive code instructions and transmit them to the processor, and the processor is configured to run the code instructions to make the apparatus execute the method described in the second aspect above.

In the eleventh aspect, an embodiment of the present application provides a system for adjusting an SRS resource, the system includes the communication apparatus described in the third aspect and the communication apparatus described in the fourth aspect, or, the system includes the communication apparatus described in the fifth aspect and the communication apparatus described in the sixth aspect, or, the system includes the communication apparatus described in the seventh aspect and the communication apparatus described in the eighth aspect, or, the system includes the communication apparatus described in the ninth aspect and the communication apparatus described in the tenth aspect.

In the twelfth aspect, an embodiment of the present disclosure provides a computer-readable storage medium, which is configured to store instructions used by the above-mentioned terminal device, and when the instructions are executed, the terminal device executes the method described in the above-mentioned first aspect.

In the thirteenth aspect, an embodiment of the present disclosure provides a readable storage medium for storing instructions used by the above-mentioned network device, and when the instructions are executed, the network device executes the method described in the above-mentioned second aspect.

In the fourteenth aspect, the present application further provides a computer program product including a computer program, which, when run on a computer, causes the computer to execute the method described in the above-mentioned first aspect.

In the fifteenth aspect, the present application further provides a computer program product including a computer program, which, when run on a computer, causes the computer to execute the method described in the above-mentioned second aspect.

In the sixteenth aspect, the present application provides a chip system, the chip system includes at least one processor and an interface, configured to support the terminal device to implement the functions involved in the first aspect, for example, determine or process at least one of data or information involved in the above method. In a possible design, the chip system further includes a memory, and the memory is configured to store necessary computer programs and data of the terminal device. The chip system may consist of chips, or may include a chip and other discrete device(s).

In the seventeenth aspect, the present application provides a chip system, the chip system includes at least one processor and an interface, configured to support the network device to implement the functions involved in the second aspect, for example, determine or process at least one of data or information involved in the above method. In a possible design, the chip system further includes a memory, and the memory is configured to store necessary computer programs and data of the network device. The chip system may consist of chips, or may include a chip and other discrete device(s).

In the eighteenth aspect, the present application provides a computer program that, when run on a computer, causes the computer to execute the method described in the first aspect above.

In the nineteenth aspect, the present application provides a computer program that, when run on a computer, causes the computer to execute the method described in the second aspect above.

### BRIEF DESCRIPTION OF THE DRAWINGS

In order to more clearly illustrate the technical solutions in the embodiments of the present application or the background, the following will describe the drawings that need to be used in the embodiments of the present application or the background.

FIG. 1 is a schematic structural diagram of a communication system provided by an embodiment of the present application;

FIG. 2 is a schematic flowchart of a method for adjusting a sounding reference signal (SRS) resource provided by an embodiment of the present application;

FIG. 3 is a schematic flowchart of a method for adjusting a sounding reference signal (SRS) provided by an embodiment of the present application;

FIG. 4 is a schematic flowchart of a method for adjusting a sounding reference signal (SRS) resource provided by an embodiment of the present application;

FIG. 5 is a schematic diagram of an SRS mapping area provided by an embodiment of the present application;

FIG. 6 is a schematic structural diagram of an apparatus for adjusting a sounding reference signal (SRS) resource provided by an embodiment of the present application;

FIG. 7 is a schematic structural diagram of an apparatus for adjusting a sounding reference signal (SRS) resource provided by an embodiment of the present application;

FIG. 8 is a schematic structural diagram of a communication apparatus provided by an embodiment of the present application;

FIG. 9 is a schematic structural diagram of another communication apparatus provided by an embodiment of the present application;

FIG. 10 is a schematic structural diagram of a chip provided by an embodiment of the present application.

### DETAILED DESCRIPTION

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of the present disclosure. Rather, they are merely examples of apparatuses and methods consistent with aspects of the disclosed embodiments as recited in the appended claims.

For ease of understanding, terms involved in the present application are firstly introduced.

### Sounding Reference Signal (SRS)

The reference signal (RS) includes a channel state information reference signal (CSI-RS), a sounding reference signal (SRS), a positioning reference signal (PRS), a tracking reference signal (TRS), etc., and the SRS includes an SRS for channel state information measurement based on codebook transmission or non-codebook transmission or an SRS for beam measurement or an SRS for positioning measurement.

In a wireless communication network, an evolved base station (Evolved Node B, eNodeB) usually allocates a part area of the system bandwidth to a specific user equipment (UE). That is, at a specific time, a specific frequency area resource is allocated to the UE. Through the SRS, the eNodeB knows the area with relatively high quality in a specific frequency area, and allocates it preferentially to the UE, so as to ensure the service quality of the UE. The SRS is used to provide reference for scheduling resources by the eNodeB.

In order to better understand the method for adjusting an SRS resource disclosed in the embodiments of the present application, the communication system to which the embodiments of the present application are applicable is firstly described below.

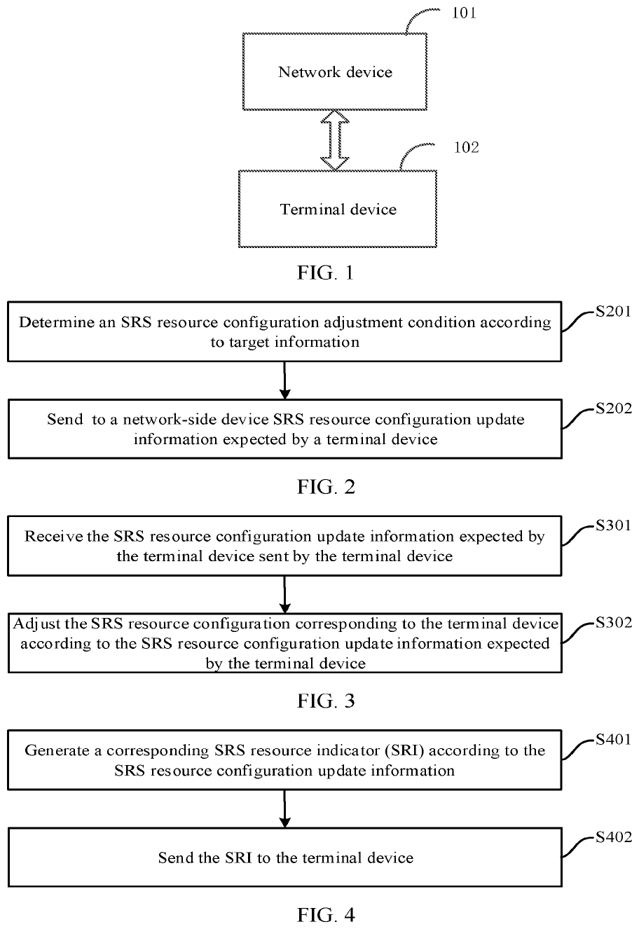

Referring to FIG. 1, which is a schematic structural diagram of a communication system provided by an embodiment of the present application, the communication system may include, but is not limited to, one network device and one terminal device. The number and form of the devices shown in FIG. 1 are for example only and do not constitute a limitation to the embodiments of the present application. In practical applications, two or more network device, two or more terminal device may be included. The communication system shown in FIG. 1 includes one network device 101 and one terminal device 102 as an example.

It should be noted that the technical solutions of the embodiments of the present application may be applied to various communication systems, for example: a long term evolution (LTE) system, a fifth generation (5th generation, 5G) mobile communication system, a 5G new radio (NR) system, or other future new mobile communication systems, etc. It should also be noted that the sidelink in the embodiments of the present application may also be referred to as a side link or a direct link.

The network device 101 in the embodiments of the present application is an entity on the network side for transmitting or receiving signals. For example, the network device 101 may be an evolved base station (evolved NodeB, eNB), a transmission point (transmission reception point, TRP), a next generation base station (next generation NodeB, gNB) in an NR system, a base station in other future mobile communication systems or an access node in a wireless fidelity (WiFi) system, etc. The embodiments of the present application do not limit the specific technology and specific device form adopted by the network device. The network device provided by the embodiments of the present application may be composed of a central unit (CU) and a distributed unit (DU), where the CU may also be called a control unit. By adopting the CU-DU structure, the protocol layer of the network device, such as the base station, can be separated, the functions of some protocol layers are placed in the CU to be centrally controlled, and the functions of the remaining part or all of the protocol layer are distributed in the DU, and the CU centrally controls the DU.

The terminal device 102 in the embodiments of the present application is an entity on the user side for receiving or transmitting signals, such as a mobile phone. The terminal device may also be called a terminal, a user equipment (UE), a mobile station (MS), a mobile terminal (MT) and so on. The terminal device may be a car with communication functions, a smart car, a mobile phone, a wearable device, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present application do not limit the specific technology and specific device form adopted by the terminal device.

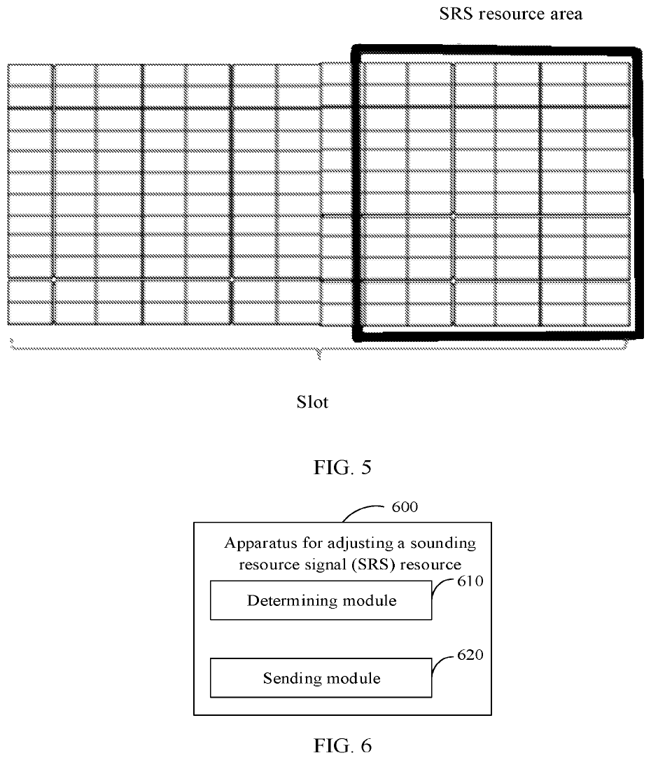

In the wireless communication, the uplink sounding reference signal (SRS) may be a periodic SRS, a Semi-Persistent Scheduling (SPS) SRS or an aperiodic (AP) SRS, may be a narrowband SRS or a wideband SRS, may be a single-port SRS or a multi-port SRS. The uplink SRS parameter may be configured by the network to the terminal, including the number of ports, a frequency domain resource location, a time domain resource location, a sequence, and a sequence cyclic offset. FIG. 5 is a schematic diagram of an SRS mapping area provided by an embodiment of the present application. As shown in FIG. 5, the network side may configure a plurality of uplink SRS sets for the terminal device, and one resource set includes one or more SRS resources. One SRS resource may be on several consecutive Orthogonal Frequency Division Multiplexing (OFDM) symbols, and SRS may be mapped on up to six OFDM symbols (SRS resource area) in one uplink slot.

In the uplink enhancement of R17, the PUSCH transmission based on multi-TRP is enhanced, and the transmission based on codebook or non-codebook may be used for the acquisition of uplink Channel State Information (CSI) through configuration of SRS. The SRS resource set is associated with different Transmission Reception Points (TRPs), and is configured for the terminal through Radio Resource Control (RRC) signaling. The terminal needs to configure at most one SRS resource set for the uplink transmission based on codebook. The SRS resource set may be configured with a plurality of SRS resources, the network side will feed back an SRS Resource Indicator (SRI) of log₂(N_{SRS}) bits, and the SRS resource is selected by indication of SRI. Similarly, based on the measurement of the uplink CSI by the base station, the network finally determines the Transmission precoding matrix indication (TPMI) and the number of transmission layers (Rank Indication, RI) used by the terminal for actual transmission and notifies the terminal. The data in the subsequent uplink transmission of the terminal needs to be precoded using the PMI and RI specified by the network side, and at the same time, the precoded data is mapped to the corresponding antenna port according to a spatial filter SpatialRelationInfo corresponding to the SRS resource indicated by the SRI. Different SRSs are transmitted using different spatial filters, so the precoded data of the terminal needs to be filtered by the spatial filter used by the SRS indicated by the SRI. In this way, the transmission of uplink data from single layer to full rank can be supported.

Table 1 is taken as an example to provide an indication method of SRI for a plurality of SRS resources. Table 2 takes 4 antenna ports as an example to respectively provide signaling indication modes of TPMI and RI for single-layer transmission, which are indicated for different UE capabilities respectively. Here, the UE capability is divided into three types: full correlation, partial correlation, and non-correlation, which represent the correlation capability of the antenna ports. Table 3 and Table 4 correspond to codewords for 4-antenna port single-layer transmission.

TABLE 1

| | SRI(s), |
|---|---|
| Bit field mapped to index | N_{SRS} = 2 |
| 0 | 0 |
| 1 | 1 |

In the NR system, the base station may configure at most one SRS resource set for the terminal for uplink transmission based on non-codebook, which is realized by configuring one SRS resource set as “noncodebook”. For the uplink transmission based on non-codebook, the terminal sends to the base station the capability of a maximum number of SRS resources that can be transmitted simultaneously. This resource set may be configured with up to 4 SRS resources, and each SRS resource contains 1 SRS port. The base station may indicate to the terminal that one or more SRS resources are used to determine the precoding of the Physical Uplink Shared Channel (PUSCH) through the SRI, and the number of SRS resources corresponding to the SRI is the number of streams transmitted by the PUSCH. When the base station configures only one SRS resource for the terminal for non-codebook uplink transmission, DCI format 0_1 does not include SRI, and the terminal determines the precoding of PUSCH according to the configured SRS resource.

The following is the SRI indication table corresponding to the transmission based on non-codebook and codebook in the protocol. Table 2 corresponds to Lₘₐₓ=1, Table 3 corresponds to Lₘₐₓ=2, and Table 4 corresponds to Lₘₐₓ=3.

TABLE 2

| Bit field | | Bit field | | Bit field | |
|---|---|---|---|---|---|
| mapped to | SRI(s), | mapped to | SRI(s), | mapped to | SRI(s), |
| index | N_{SRS} = 2 | index | N_{SRS} = 3 | index | N_{SRS} = 4 |
| 0 | 0 | 0 | 0 | 0 | 0 |
| 1 | 1 | 1 | 1 | 1 | 1 |
| | | 2 | 2 | 2 | 2 |
| | | 3 | reserved | 3 | 3 |

TABLE 3

| Bit field | | Bit field | | Bit field | |
|---|---|---|---|---|---|
| mapped to | SRI(s), | mapped to | SRI(s), | mapped to | SRI(s), |
| index | N_{SRS} = 2 | index | N_{SRS} = 3 | index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6-9 | reserved | 6 | 0, 3 |
| | | | | 7 | 1, 2 |
| | | | | 8 | 1, 3 |
| | | | | 9 | 2, 3 |
| | | | | 10-15 | reserved |

TABLE 4

| Bit field | | Bit field | | Bit field | |
|---|---|---|---|---|---|
| mapped to | SRI(s), | mapped to | SRI(s), | mapped to | SRI(s), |
| index | N_{SRS} = 2 | index | N_{SRS} = 3 | index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14-15 | reserved |

In the PUSCH transmission based on multi-TRP, regardless of scheme based on codebook or non-codebook, the coordinated transmission of two TRPs is currently supported, and one SRS resource set is configured for each TRP and indicated to the UE through SRI.

In the related art, in order to avoid RRC reconfiguration as much as possible, the largest SRS set is generally selected and configured for the terminal, which causes a large signaling overhead and cannot well adapt to the terminal capability, the change of channel or the change of interference. At the same time, as the number of antenna panels increases, the problems of flexibility and signaling overhead will become more prominent.

It can be understood that the communication system described in the embodiments of the present application is to illustrate the technical solutions of the embodiments of the present application more clearly, and does not constitute a limitation to the technical solutions provided in the embodiments of the present application. The person skilled in the art may know that with the evolution of the system architecture and the emergence of new service scenarios, the technical solutions provided in the embodiments of the present application are also applicable to similar technical problems.

The method and apparatus for adjusting a sounding reference signal (SRS) resource provided by the present application will be described in detail below with reference to the accompanying drawings.

Referring to FIG. 2, which is a schematic flowchart of a method for adjusting a sounding reference signal (SRS) resource provided by an embodiment of the present application, the method may be applied to a terminal device. As shown in FIG. 2, the method may include but not limited to the following steps.

In step S201: an SRS resource configuration adjustment condition is determined according to target information.

In the embodiments of the present application, several antenna panels are set on the terminal device, and the antenna panels are used to receive beams sent by the network-side device, so as to obtain signals in the beams. In the uplink enhancement of R17, the PUSCH transmission based on multi-TRP is enhanced. The transmission based on codebook or non-codebook can be used for acquisition of CSI through configuration of SRS. The SRS resource set is associated with different TRPs, and configured to the terminal device through RRC signaling. In order to improve the quality of beams received by the terminal device, the embodiments of the present application determine the SRS adjustment condition corresponding to the antenna Panel according to the target information. The target information includes at least one of the following: measurement information of channel state information (CSI) of at least one Panel; measurement information of beam management of the at least one Panel; or change information of antenna usage state of the at least one Panel. The terminal device may obtain the beam information of at least one Panel or TRP through beam management, or obtain the channel state of at least one TRP or Panel corresponding to the CSI through downlink CSI, or obtain the change information of the antenna usage state of the at least one Panel, so as to further acquire the SRS resource configuration update information expected by the terminal device.

In step S202: SRS resource configuration update information expected by the terminal device is sent to the network-side device.

In the embodiments of the present application, after the SRS resource configuration adjustment condition is determined according to the target information, the change of the Panel on the terminal device, the change of channel or the change of interference can be determined according to the SRS resource configuration adjustment condition. According to the SRS resource configuration adjustment condition, the SRS resource set expected by the Panel on the terminal device or the target SRS resource in the SRS resource set can be determined, and written into the SRS resource configuration update information. The terminal device sends the SRS resource configuration update information expected by the terminal device to instruct the network-side device to adjust the SRS resource configuration corresponding to the terminal device, so as to improve the quality of the beam received by the Panel in the terminal device.

By implementing the embodiments of the present application, it is possible to determine the SRS resource configuration update information expected by the terminal device through the target information. In this way, it is possible to prevent the SRS set configuration from not adapting to the capability of the terminal device and the change of the channel or the change of the interference, thereby helping to avoid waste of resources.

Optionally, the terminal device includes at least one antenna panel (Panel), and the target information includes at least one of the following:
measurement information of channel state information (CSI) of the at least one Panel;
measurement information of beam management of the at least one Panel;
change information of an antenna use state of the at least one Panel.

In the implementation of the present application, the terminal device may obtain the beam information of at least one Panel or TRP through beam management, or obtain the channel state of at least one TRP or Panel corresponding to the CSI through downlink CSI, or obtain the change information of the antenna use state of at least one Panel, to further acquire the SRS resource configuration update information expected by the terminal device.

Optionally, each Panel in the terminal device corresponds to at least one SRS resource set, and each SRS resource set includes at least one SRS resource.

In the embodiments of the present application, the transmission based on codebook or non-codebook can be used for acquiring uplink CSI through configuration of SRS, and the SRS resource set is associated with different Panels and configured to UE through RRC.

Optionally, the SRS resource configuration update information includes one or more of the following:
an activation state of an expected SRS resource set on a target Panel;
an activation state of a target SRS resource in the expected SRS resource set on the target Panel.

In the embodiments of the present application, it is necessary to adjust the corresponding SRS resource activation state for the target Panel that needs to adjust the corresponding SRS resource. When the target Panel needs to adjust the activation state of the expected SRS resource set, it adjusts the activation state of the expected SRS resource on the target Panel; when the target Panel needs to adjust the activation state of the target SRS resource in the expected SRS resource set, it adjusts the activation state of the target SRS resource in the expected SRS resource set on the target Panel. The target SRS resource is the SRS resource expected by the target Panel.

Optionally, the target Panel is one of the following:
all Panels on the terminal device;
a Panel with a channel state change meeting the SRS resource adjustment condition on the terminal device;
a specific Panel on the terminal device.

In the embodiments of the present application, the target Panel may be all Panels on the terminal device. If a part of the Panels on the terminal device does not need to adjust its corresponding SRS resource, it is determined that it is not the target Panel.

In a possible embodiment, a Panel whose channel state change meets the SRS resource adjustment condition on the terminal device is determined as the target Panel.

In a possible embodiment, a specific Panel on the terminal device is determined as the target Panel. For example, after one or more Panels of the terminal device are replaced, the TRP corresponding to the replaced one or more Panels changes. Then it is necessary to determine the replaced one or more Panels as the target Panel.

By implementing the embodiments of the present application, it is possible to determine the SRS resource configuration update information expected by the terminal device through the target Panel. In this way, it is possible to prevent the configuration of the SRS set from not adapting to the capabilities of some or all Panels on the terminal device, as well as the change of channel or the change of interference, thereby helping to avoid resource waste and improve beam transmission quality.

Optionally, the target SRS resource is all SRS resources or a specific SRS resource in the corresponding SRS resource set.

Optionally, the SRS resource configuration update information expected by the terminal device is carried by Radio Resource Control (RRC) signaling, Media Access Control-Control Element (MAC-CE) signaling or uplink control information (UCI).

In the implementation of the present application, the terminal device may carry the SRS resource configuration update information expected by the terminal device in multiple ways. In a possible embodiment, the terminal device carries the SRS resource configuration update information expected by the terminal device through RRC signaling and sends it to the network-side device. In another possible embodiment, the terminal device carries the SRS resource configuration update information expected by the terminal device through MAC-CE signaling and sends it to the network-side device. In another possible embodiment, the terminal device carries the SRS resource configuration update information expected by the terminal device through UCI and sends it to the network-side device.

By implementing the embodiments of the present application, the SRS resource configuration update information expected by the terminal device can be reported by the radio resource control (RRC) signaling, the medium access control-control element (MAC-CE) signaling or the uplink control information (UCI). In this way, it is possible to prevent the SRS set configuration from not adapting to the capability of the terminal device and the change of the channel or the change of the interference, thereby helping to avoid waste of resources and improve beam transmission quality.

Optionally, the SRS resource configuration update information includes one of the following items:
a first bitmap (Bitmap), where the SRS resource configuration update information of each Panel is independently indicated in the first Bitmap, and the SRS configuration update information of a plurality of Panels are indicated in sequence;
a second Bitmap, where the SRS resource configuration update information of all Panels is jointly indicated through the second Bitmap;
a first codepoint (Codepoint), where the first Codepoint indicates the SRS resource configuration update information of each Panel independently, and indicates the SRS configuration update information of a plurality of Panels in sequence;
a second Codepoint, where the SRS resource configuration update information of all Panels is jointly indicated through the second Codepoint.

In the embodiments of the present application, the terminal device carries the SRS resource configuration update information expected by the terminal device through RRC signaling, and further, indicates the SRS resource configuration update information expected by the terminal device through the first Bitmap in the RRC signaling, where the SRS resource configuration update information of each Panel is independently indicated in the first Bitmap, and the SRS configuration update information of a plurality of Panels is indicated sequentially.

In a possible embodiment, the terminal device carries the SRS resource configuration update information expected by the terminal device through RRC signaling, and further, indicates the SRS resource configuration update information expected by the terminal device through the second Bitmap in the RRC signaling, where the SRS resource configuration update information of all Panels is jointly indicated by the second Bitmap.

In a possible embodiment, the terminal device carries the SRS resource configuration update information expected by the terminal device through RRC signaling, and further, indicates the SRS resource configuration update information expected by the terminal device through the first Codepoint in the RRC signaling, where the first Codepoint indicates the SRS resource configuration update information of each Panel correspondingly and independently, and the SRS configuration update information of a plurality of Panels is indicated sequentially.

In a possible embodiment, the terminal device carries the SRS resource configuration update information expected by the terminal device through RRC signaling, and further, indicates the SRS resource configuration update information expected by the terminal device through the second Codepoint in the RRC signaling, where the SRS resource configuration update information of all Panels is jointly indicated by the second Codepoint.

Optionally, the method also includes:
sending one or more of an ID of the SRS resource set and an ID of the target Panel to the network-side device.

In the embodiments of the present application, the terminal device sends one or more of the ID of the SRS resource set and the ID of the target Panel through RRC signaling.

Optionally, when the SRS resource configuration update information expected by the terminal device is carried by the UCI signaling, the method includes one of the following:
sending the SRS resource configuration update information expected by the terminal device through a channel state information (CSI) report quantity;
reporting through a periodic CSI configuration measurement;
reporting through a semi-static CSI configuration measurement;
reporting through an aperiodic CSI configuration measurement.

In the embodiments of the present application, the terminal device carries the SRS resource configuration update information expected by the terminal device through UCI signaling, and sends the SRS resource configuration update information through the CSI report quantity. In a possible embodiment, the terminal device sends the SRS resource configuration update information expected by the terminal device by increasing the CSI report quantity in the UCI signaling.

In a possible embodiment, the SRS resource configuration update information expected by the terminal device is carried by UCI signaling, and further, the SRS resource configuration update information expected by the terminal device is reported through the periodic CSI configuration measurement in the UCI signaling.

In a possible embodiment, the SRS resource configuration update information expected by the terminal device is carried through UCI signaling, and further, the SRS resource configuration update information expected by the terminal device is reported through the semi-static CSI configuration measurement in the UCI signaling.

In a possible embodiment, the SRS resource configuration update information expected by the terminal device is carried through UCI signaling, and further, the SRS resource configuration update information expected by the terminal device is reported through the aperiodic CSI configuration measurement in the UCI signaling.

Optionally, the SRS resource is used for codebook transmission or non-codebook transmission, and the SRS resource is one of the following:
a periodic P-SRS resource;
a semi-static SP-SRS resource;
an aperiodic AP-SRS resource.

Referring to FIG. 3, which is a schematic flowchart of a method for adjusting a sounding reference signal (SRS) resource provided by an embodiment of the present application, the method may be applied to a network-side device. As shown in FIG. 3, the method may include but not limited to the following steps.

In step S301: SRS resource configuration update information expected by a terminal device sent by the terminal device is received.

In the embodiment of the present application, after the terminal device determines the SRS resource configuration adjustment condition according to the target information, it determines the change of the Panel on the terminal device, the change of channel interference or the change of channel according to the SRS resource configuration adjustment condition. According to the SRS resource configuration adjustment condition, the SRS resource set expected by the Panel on the terminal device or the target SRS resource in the SRS resource set can be determined, and written into the SRS resource configuration update information. The terminal device uses the SRS resource configuration update information expected by the terminal device to instruct the network-side device to adjust the SRS resource configuration corresponding to the terminal device. The network-side device parses the RRC signaling, MAC-CE signaling or UCI sent by the terminal device to obtain the SRS resource configuration update information expected by the terminal device.

In step S302: an SRS resource configuration corresponding to the terminal device is adjusted according to the SRS resource configuration update information expected by the terminal device.

In the embodiment of the present application, the network-side device generates a corresponding SRS resource indicator (SRI) according to the SRS resource configuration update information expected by the terminal device, and sends the SRI to the terminal device to adjust the SRS resource configuration corresponding to the terminal device.

By implementing the embodiments of the present application, it is possible to adjust the SRS resource configuration corresponding to the terminal device through the SRS resource configuration update information expected by the terminal device. In this way, it is possible to prevent the SRS set configuration from not adapting to the capability of the terminal device and the change of the channel or the change of the interference, thereby helping to avoid waste of resources.

Optionally, the terminal device includes at least one antenna panel (Panel), and each antenna panel (Panel) in the terminal device corresponds to at least one SRS resource set, and each SRS resource set includes at least one SRS resource.

In the embodiment of the present application, the transmission based on codebook or non-codebook can be used for acquiring uplink CSI through SRS configuration, and the SRS resource set is associated with different Panels and configured to the terminal device through RRC.

Optionally, the SRS resource configuration update information includes one or more of the following:
an activation state of an expected SRS resource set on a target Panel;
an activation state of a target SRS resource in the expected SRS resource set on the target Panel.

In the embodiment of the present application, the network-side device needs to adjust the corresponding SRS resource activation state for the target Panel that needs to adjust the corresponding SRS resource. When the target Panel needs to adjust the activation state of the expected SRS resource set, it adjusts the activation state of the expected SRS resource set on the target panel; when the target Panel needs to adjust the activation state of the target SRS resource in the expected SRS resource set, then it adjusts the activation state of the target SRS resource in the expected SRS resource set on the target Panel. The target SRS resource is the SRS resource expected by the target Panel.

Optionally, the target Panel is one of the following:
all Panels on the terminal device;
a Panel on the terminal device that has a channel state change meeting the SRS resource adjustment condition;
a specific Panel on the terminal device.

In the embodiment of the present application, the target Panel may be all Panels on the terminal device. If a part of the Panels on the terminal device does not need to adjust its corresponding SRS resource, it is determined that it is not the target Panel.

In a possible embodiment, a Panel, on the terminal device, whose channel state change meets the SRS resource adjustment condition is determined as the target Panel.

In a possible embodiment, a specific Panel on the terminal device is determined as the target Panel. For example, after one or more Panels of the terminal device are replaced, the TRP corresponding to the replaced one or more Panels changes, then it is necessary to determine the replaced one or more Panels as the target Panel.

By implementing the embodiment of the present application, it is possible to determine the SRS resource configuration update information expected by the terminal device through the target Panel. In this way, it is possible to prevent the SRS set configuration from not adapting to the capabilities of some or all Panels on the terminal device, and the channel change or interference change, thereby helping to avoid resource waste and improve beam transmission quality.

Optionally, the target SRS resource is all SRS resources or a specific SRS resource in the corresponding SRS resource set.

Optionally, the SRS resource configuration update information is carried by radio resource control (RRC) signaling, medium access control-control element (MAC-CE) signaling or uplink control information (UCI).

In the implementation of the present application, the network-side device may receive the SRS resource configuration update information desired by the terminal device in various ways, and the terminal device may carry the SRS resource configuration update information desired by the terminal device in multiple ways. In a possible embodiment, the terminal device carries the SRS resource configuration update information expected by the terminal device through RRC signaling and sends it to the network-side device. In another possible embodiment, the terminal device carries the SRS resource configuration update information expected by the terminal device through MAC-CE signaling and sends it to the network-side device. In another possible embodiment, the terminal device carries the SRS resource configuration update information expected by the terminal device through UCI and sends it to the network-side device.

By implementing the embodiments of the present application, the SRS resource configuration update information desired by the terminal device can be received through radio resource control (RRC) signaling, medium access control-control element (MAC-CE) signaling or uplink control information (UCI). In this way, it is possible to prevent the SRS set configuration from not adapting to the capability of the terminal device and the change of the channel or the change of the interference, thereby helping to avoid waste of resources and improve beam transmission quality.

Optionally, the SRS resource configuration update information includes one of the following items:
a first bitmap (Bitmap), where the SRS resource configuration update information of each Panel is independently indicated in the first Bitmap, and the SRS configuration update information of a plurality of Panels is indicated sequentially;
a second Bitmap, where the SRS resource configuration update information of all Panels is jointly indicated through the second Bitmap;
a first codepoint (Codepoint), where the first Codepoint indicates the SRS resource configuration update information of each Panel correspondingly and independently, and indicates the SRS configuration update information of a plurality of Panels in sequence;
a second Codepoint, where the SRS resource configuration update information of all Panels is jointly indicated through the second Codepoint.

In the embodiment of the present application, the network-side device receives the SRS resource configuration update information expected by the terminal device through RRC signaling, and further, the SRS resource configuration update information expected by the terminal device is indicated through the first Bitmap in the RRC signaling, where the SRS resource configuration update information of each Panel is independently indicated in the first Bitmap, and the SRS configuration update information of a plurality of Panels is indicated sequentially.

In a possible embodiment, the network-side device receives the SRS resource configuration update information expected by the terminal device through RRC signaling, and further, the SRS resource configuration update information expected by the terminal device is indicated through the second Bitmap in the RRC signaling. The SRS resource configuration update information of all Panels is jointly indicated by the second Bitmap.

In a possible embodiment, the network-side device receives the SRS resource configuration update information expected by the terminal device through RRC signaling, and the SRS resource configuration update information expected by the terminal device is indicated through the first Codepoint in the RRC signaling. The SRS resource configuration update information corresponding to each Panel is independently indicated by the first Codepoint, and the SRS configuration update information of a plurality of Panels is indicated sequentially.

In a possible embodiment, the network-side device receives the SRS resource configuration update information expected by the terminal device through RRC signaling, and further, the SRS resource configuration update information expected by the terminal device is indicated through the second Codepoint in the RRC signaling. The SRS resource configuration update information of all Panels is jointly indicated by the second Codepoint.

Optionally, the method also includes:
receiving one or more of an ID of the SRS resource set and an ID of the target Panel sent by the terminal device.

In the embodiment of the present application, the network-side device receives one or more of the ID of the SRS resource set and the ID of the target Panel through RRC signaling.

Optionally, when the SRS resource configuration update information expected by the terminal device is carried by the UCI signaling, the method includes one of the following:
receiving the SRS resource configuration update information expected by the terminal device through a channel state information (CSI) report quantity;
receiving through a periodic CSI configuration measurement;
receiving through a semi-static CSI configuration measurement;
receiving through an aperiodic CSI configuration measurement.

In the embodiment of the present application, the network-side device receives the SRS resource configuration update information expected by the terminal device through UCI signaling, and receives the SRS resource configuration update information through the CSI report quantity. In a possible embodiment, the terminal device receives the SRS resource configuration update information expected by the terminal device by increasing the CSI report quantity in the UCI signaling.

In a possible embodiment, the network-side device receives the SRS resource configuration update information expected by the terminal device through UCI signaling, and further, the SRS resource configuration update information expected by the terminal device is reported through the periodic CSI configuration measurement in the UCI signaling.

In a possible embodiment, the network-side device receives the SRS resource configuration update information expected by the terminal device through UCI signaling, and further, the SRS resource configuration update information expected by the terminal device is reported through the semi-static CSI configuration measurement in the UCI signaling.

In a possible embodiment, the network-side device receives the SRS resource configuration update information expected by the terminal device through UCI signaling, and further, the SRS resource configuration update information expected by the terminal device is reported through the aperiodic CSI configuration measurement in the UCI signaling.

Optionally, the SRS resource is used for codebook transmission or non-codebook transmission, and the SRS resource is one of the following:
a periodic P-SRS resource;
a semi-static SP-SRS resource;
an aperiodic AP-SRS resource.

Referring to FIG. 4, which is a schematic flowchart of a method for adjusting a sounding reference signal (SRS) resource provided by an embodiment of the present application, the method may be applied to a network-side device. As shown in FIG. 4, the method may include but not limited to the following steps.

In step S401: a corresponding SRS resource indicator (SRI) is generated according to the SRS resource configuration update information.

In the embodiment of the present application, the network-side device receives the RRC signaling, MAC-CE signaling or UCI sent by the terminal device, parses it to obtain the SRS resource configuration update information expected by the terminal device, and configures a corresponding SRS resource for the Panel on the terminal device according to the SRS resource configuration update information expected by the terminal device. The SRS resource corresponding to the Panel configuration on the terminal device is carried by the SRS resource indicator (SRI).

In step S402: the SRI is sent to the terminal device.

In the embodiment of the present application, the network-side device sends the SRI to the terminal device, adjusts the SRS resource configuration corresponding to the terminal device, and improves the quality of the beam received by the Panel in the terminal device.

By implementing the embodiments of the present application, the SRS resource configuration corresponding to the terminal device can be adjusted through the SRI. In this way, it is possible to prevent the SRS set configuration from not adapting to the capability of the terminal device and the change of the channel or the change of the interference, thereby helping to avoid waste of resources and improve beam transmission quality.

In the above-mentioned embodiments provided in the present application, the methods provided in the embodiments of the present application are introduced from the perspectives of the network device and the terminal device respectively. In order to realize the various functions in the method provided by the above-mentioned embodiments of the present application, the network device and the terminal device may include a hardware structure and a software module, and realize the above-mentioned functions in the form of a hardware structure, a software module, or a hardware structure plus a software module. A certain function among the above-mentioned functions may be implemented in the form of a hardware structure, a software module, or a hardware structure plus a software module.

Referring to FIG. 8, which is a schematic structural diagram of a communication apparatus 80 provided in an embodiment of the present application, the communication apparatus 80 shown in FIG. 8 may include a transceiver module 801 and a processing module 802. The transceiver module 801 may include a sending module and/or a receiving module, the sending module is configured to realize the sending function, the receiving module is configured to realize the receiving function, and the transceiver module 801 can realize the sending function and/or the receiving function.

The communication apparatus 80 may be a terminal device (such as the terminal device in the foregoing method embodiments), may also be an apparatus in the terminal device, and may also be an apparatus that can be matched with the terminal device. Alternatively, the communication apparatus 80 may be a network device, or an apparatus in the network device, or an apparatus that can be matched with the network device.

The communication apparatus 80 is a terminal device (such as the terminal device in the foregoing method embodiments): as shown in FIG. 6, the apparatus 600 for adjusting an SRS resource includes:
a determining module 610, configured to determine an SRS resource configuration adjustment condition according to target information;
a sending module 620, configured to send SRS resource configuration update information expected by the terminal device to a network-side device.

Optionally, the terminal device includes at least one antenna panel (Panel), and the target information includes at least one of the following:
measurement information of channel state information (CSI) of the at least one Panel;
measurement information of beam management of the at least one Panel;
change information of an antenna use state of the at least one Panel.

Optionally, each Panel in the terminal device corresponds to at least one SRS resource set, and each SRS resource set includes at least one SRS resource.

Optionally, the SRS resource configuration update information includes one or more of the following:
an activation state of an expected SRS resource set on the target Panel;
an activation state of a target SRS resource in the expected SRS resource set on the target Panel.

Optionally, the target Panel is one of the following:
all Panels on the terminal device;
a Panel on the terminal device that has a channel state change meeting the SRS resource adjustment condition;
a specific Panel on the terminal device.

Optionally, the target SRS resource is all SRS resources or a specific SRS resource in the corresponding SRS resource set.

Optionally, the SRS resource configuration update information expected by the terminal device is carried by Radio resource control (RRC) signaling, Media Access Control-Control Element (MAC-CE) signaling or uplink control information (UCI).

Optionally, the SRS resource configuration update information includes one of the following items:
a first bitmap (Bitmap), where the SRS resource configuration update information of each Panel is independently indicated in the first Bitmap, and the SRS configuration update information of a plurality of Panels are indicated sequentially;
a second Bitmap, where the SRS resource configuration update information of all Panels is jointly indicated through the second Bitmap;
a first codepoint (Codepoint), where the first Codepoint indicates the SRS resource configuration update information of each Panel correspondingly and independently, and the SRS configuration update information of a plurality of Panels is indicated in sequence;
a second Codepoint, where the SRS resource configuration update information of all Panels is jointly indicated through the second Codepoint.

Optionally, the apparatus also includes:
a first sending submodule, configured to send one or more of an ID of the SRS resource set and an ID of the target Panel to the network-side device.

Optionally, when the SRS resource configuration update information expected by the terminal device is carried by the UCI signaling, the method includes one of the following:
a second sending submodule, configured to send the SRS resource configuration update information through a channel state information (CSI) report quantity;
a third sending submodule, configured to report through a periodic CSI configuration measurement;
a fourth sending submodule, configured to report through a semi-static CSI configuration measurement;
a fifth sending submodule, configured to report through an aperiodic CSI configuration measurement.

Optionally, the SRS resource is used for codebook transmission or non-codebook transmission, and the SRS resource is one of the following:
a periodic P-SRS resources
a semi-static SP-SRS resource;
an aperiodic AP-SRS resource.

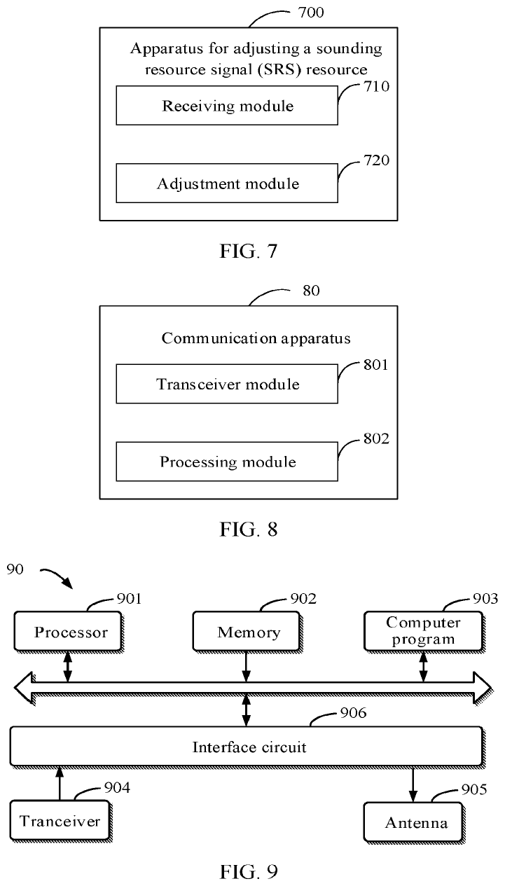

The communication apparatus 80 is a network device: as shown in FIG. 7, the apparatus 700 for adjusting an SRS resource includes:
a receiving module 710, configured to receive SRS resource configuration update information expected by the terminal device sent by the terminal device;
an adjustment module 720, configured to adjust an SRS resource configuration corresponding to the terminal device according to the SRS resource configuration update information expected by the terminal device.

Optionally, the terminal device includes at least one antenna panel (Panel), and each antenna panel (Panel) in the terminal device corresponds to at least one SRS resource set, and each SRS resource set includes at least one SRS resource.

Optionally, the SRS resource configuration update information includes one or more of the following:
an activation state of an expected SRS resource set on the target Panel;
an activation state of a target SRS resource in the expected SRS resource set on the target Panel.

Optionally, the target Panel is one of the following:
all Panels on the terminal device;
a Panel on the terminal device that has a channel state change meeting the SRS resource adjustment condition;
a specific Panel on the terminal device.

Optionally, the target SRS resource is all SRS resources or a specific SRS resource in the corresponding SRS resource set.

Optionally, the SRS resource configuration update information is carried by radio resource control (RRC) signaling, medium access control-control element (MAC-CE) signaling or uplink control information (UCI).

Optionally, the SRS resource configuration update information includes one of the following items:
a first bitmap (Bitmap), where the SRS resource configuration update information of each Panel is independently indicated in the first Bitmap, and the SRS configuration update information of multiple Panels are indicated sequentially;
a second Bitmap, where the SRS resource configuration update information of all Panels is jointly indicated through the second Bitmap;
a first codepoint (Codepoint), where the first Codepoint indicates the SRS resource configuration update information of each Panel correspondingly and independently, and the SRS configuration update information of multiple Panels is indicated in sequence;
a second Codepoint, where the SRS resource configuration update information of all Panels is jointly indicated through the second Codepoint.

Optionally, the apparatus also includes:
a first receiving submodule, configured to receive one or more of an ID of the SRS resource set and an ID of the target Panel sent by the terminal device.

Optionally, when the SRS resource configuration update information expected by the terminal device is carried by the UCI signaling, the method includes one of the following:
a second receiving submodule, configured to receive the SRS resource configuration update information through a channel state information (CSI) report quantity;
a third receiving submodule, configured to receive through periodic CSI configuration measurement;
a fourth receiving submodule, configured to receive through semi-static CSI configuration measurement;
a fifth receiving submodule, configured to receive through aperiodic CSI configuration reception.

Optionally, the SRS resource is used for codebook transmission or non-codebook transmission, and the SRS resource is one of the following:
a periodic P-SRS resource;
a semi-static SP-SRS resource;
an aperiodic AP-SRS resource.

Optionally, the adjustment module includes:
a generating submodule, configured to generate a corresponding SRS resource indicator (SRI) according to the SRS resource configuration update information;
a sending submodule, configured to send the SRI to the terminal device.

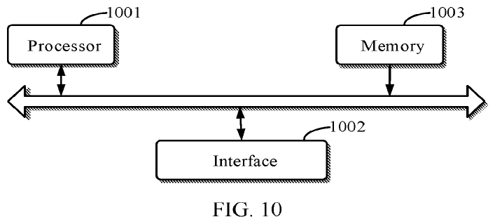

Referring to FIG. 9, which is a schematic structural diagram of another communication apparatus 90 provided in an embodiment of the present application, the communication apparatus 90 may be a network device, or a terminal device (such as the terminal device in the aforementioned method embodiments), or a chip, a chip system, or a processor that supports the network device to implement the above methods, or it may also be a chip, a chip system, or a processor that supports the terminal device to implements the above methods. The apparatus can be used to implement the methods described in the above method embodiments, and for details, the descriptions in the above method embodiments may be referred to.

The communication apparatus 90 may include one or more processors 901. The processor 901 may be a general-purpose processor or a special-purpose processor or the like. For example, it can be a baseband processor or a central processing unit. The baseband processor can be used to process communication protocols and communication data, and the central processing unit can be used to control communication apparatuses (such as base stations, baseband chips, terminal devices, terminal device chips, DUs or CUS, etc.), execute computer programs, and process data of computer programs.

Optionally, the communication apparatus 90 may further include one or more memories 902, on which a computer program 903 may be stored, and the processor 901 executes the computer program 903, so that the communication apparatus 90 executes the method described in the above method embodiments. Optionally, data may also be stored in the memory 902. The communication apparatus 90 and the memory 902 can be set separately or integrated together.

Optionally, the communication apparatus 90 may further include a transceiver 904 and an antenna 905. The transceiver 904 may be called a transceiver unit, a transceiver, or a transceiver circuit, etc., and is used to implement a transceiver function. The transceiver 904 may include a receiver and a transmitter, and the receiver may be called a receiver or a receiving circuit for realizing a receiving function; the transmitter may be called a sender or a sending circuit for realizing a sending function.

Optionally, the communication apparatus 90 may further include one or more interface circuits 906. The interface circuit 906 is used to receive code instructions and transmit them to the processor 901. The processor 901 runs the code instructions to enable the communication apparatus 90 to execute the methods described in the foregoing method embodiments.

The communication apparatus 90 is a terminal device (such as the terminal device in the foregoing method embodiments): the processor 901 is configured to execute steps S201 and S202 in FIG. 2.

The communication apparatus 90 is a network device: the transceiver 904 is used to execute step S301 in FIG. 3; and execute step S402 in FIG. 4. The processor 901 is configured to execute step S302 in FIG. 3; and execute step S401 in FIG. 4.

In an implementation, the processor 901 may include a transceiver for implementing receiving and sending functions. For example, the transceiver may be a transceiver circuit, or an interface, or an interface circuit. The transceiver circuit, interface or interface circuit for realizing the functions of receiving and sending can be separated or integrated together. The above-mentioned transceiver circuit, interface or interface circuit may be used for reading and writing code/data, or the above-mentioned transceiver circuit, interface or interface circuit may be used for signal transmission or transfer.

In an implementation, the processor 901 may store a computer program 903, and the computer program 903 runs on the processor 901, and may cause the communication apparatus 90 to execute the methods described in the foregoing method embodiments. The computer program 903 may be solidified in the processor 901, and in this case, the processor 901 may be implemented by hardware.

In an implementation, the communication apparatus 90 may include a circuit, and the circuit may implement the function of sending or receiving or communicating in the foregoing method embodiments. The processors and transceivers described in the present application can be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and the transceiver can also be fabricated using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be a network device or a terminal device (such as the terminal device in the above-mentioned method embodiments), but the scope of the communication apparatus described in the present application is not limited thereto, and the structure of the communication apparatus may not be limited by FIG. 9. The communication apparatus may be a stand-alone device or may be part of a relatively large device. For example, the communication apparatus may be:
(1) a stand-alone integrated circuit (IC), or a chip, or a chip system or a subsystem;
(2) a set with one or more ICs, optionally, the set of ICs may also include a storage component for storing data and the computer program;
(3) ASIC, such as a Modem;
(4) a module that can be embedded in another device;
(5) a receiver, a terminal device, an intelligent terminal device, a cellular phone, a wireless device, a handset, a mobile unit, a vehicle device, a network device, a cloud device, an artificial intelligence device, etc.;
(6) others and so on.

For the case where the communication apparatus may be a chip or a chip system, the schematic structural diagram of the chip shown in FIG. 10 may be referred to. The chip shown in FIG. 10 includes a processor 1001 and an interface 1002. The number of the processor 1001 may be one or more, and the number of the interface 1002 may be more than one.

Optionally, the chip further includes a memory 1003 for storing necessary computer programs and data.

Those skilled in the art can also understand that various illustrative logical blocks and steps listed in the embodiments of the present application can be implemented by an electronic hardware, computer software, or a combination of both. Whether such functions are implemented by hardware or software depends on the specific application and the design requirements of the overall system. Those skilled in the art may use various methods to implement the described functions for each specific application, but such implementation should not be understood as going beyond the protection scope of the embodiments of the present application.

The embodiment of the present application also provides a system for adjusting a sounding reference signal (SRS) resource. The system includes the communication apparatus serving as the terminal device (such as the terminal device in the foregoing method embodiments) in the embodiment of FIG. 8 and the communication apparatus serving as the network device. Alternatively, the system includes the communication apparatus serving as the terminal device (such as the terminal device in the foregoing method embodiments) and the communication apparatus serving as the network device in the aforementioned embodiment in FIG. 9.

The present application also provides a readable storage medium on which instructions are stored, and when the instructions are executed by a computer, the functions of any one of the above method embodiments are realized.

The present application also provides a computer program product, which implements the functions of any one of the above method embodiments when the computer program product is executed by a computer.

In the above embodiments, all or part of them may be implemented by software, hardware, firmware or any combination thereof. When implemented using software, it may be implemented in whole or in part in the form of a computer program product. The computer program product includes one or more computer programs. When the computer program is loaded and executed on the computer, all or part of the processes or functions according to the embodiments of the present application are generated. The computer can be a general purpose computer, a special purpose computer, a computer network, or other programmable apparatuses. The computer program can be stored in the computer-readable storage medium or transmitted from one computer-readable storage medium to another computer-readable storage medium, for example, the computer program can be transmitted from one website, computer, server or data center to another website site, computer, server or data center by wired (such as a coaxial cable, an optical fiber, a digital subscriber line (DSL)) or wireless (such as infrared, wireless, microwave, etc.) manner. The computer-readable storage medium may be any available medium that can be accessed by a computer, or a data storage device such as a server or a data center integrated with one or more available media. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those of ordinary skill in the art can understand that the first, second, and other numbers involved in the present application are only for convenience of description, and are not used to limit the scope of the embodiments of the present application, and also indicate the sequence.

At least one in the present application can also be described as one or more, and a plurality of can be two, three, four or more, which is not limited in the present application. In the embodiments of the present application, for a technical feature, the technical features are distinguished by “first”, “second”, “third”, “A”, “B”, “C” and “D”, etc. The technical features described by the “first”, “second”, “third”, “A”, “B”, “C” and “D” have no sequence or order of magnitude therebetween.

The corresponding relationships shown in the tables in the present application can be configured or predefined. The values of the information in each table are just examples, and may be configured as other values, which are not limited in the present application. When configuring the corresponding relationship between the information and each parameter, it is not necessarily required to configure all the corresponding relationships shown in the tables. For example, in the table in the present application, the corresponding relationship shown in some rows may not be configured. For another example, appropriate deformation adjustments can be made based on the above tables, for example, splitting, merging, and so on. The names of the parameters shown in the titles of the above tables may also adopt other names understandable by the communication apparatus, and the values or representations of the parameters may also be other values or representations understandable by the communication apparatus. When the above tables are implemented, other data structures can also be used, for example, arrays, queues, containers, stacks, linear tables, pointers, linked lists, trees, graphs, structures, classes, heaps, hashtables or hash tables.

The predefining in the present application can be understood as defining, defining in advance, storing, pre-storing, pre-negotiating, pre-configuring, curing, or pre-firing.

Those skilled in the art can appreciate that the units and algorithm steps of the examples described in conjunction with the embodiments disclosed herein can be implemented by an electronic hardware, or a combination of computer software and the electronic hardware. Whether these functions are executed by hardware or software depends on the specific application and design constraints of the technical solution. Skilled artisans may implement the described functions using different methods for each particular application, but such implementation should not be considered as going beyond the scope of the present application.

Those skilled in the art can clearly understand that for the convenience and brevity of the description, the specific working process of the above-described system, apparatus and unit may refer to the corresponding process in the foregoing method embodiments, which will not be repeated here.

The above is only the specific implementation of the present application, and the scope of protection of the present application is not limited thereto. Anyone skilled in the art can easily think of changes or substitutions within the technical scope of the present application, which should fall within the protection scope of the present application. Therefore, the protection scope of the present application should be determined by the protection scope of the claims.

What is claimed is:

1. A method for adjusting a sounding reference signal (SRS) resource, applied to a terminal device, wherein the method comprises:
determining an SRS resource configuration adjustment condition according to target information; and
sending SRS resource configuration update information expected by the terminal device to a network-side device.

2. The method according to claim 1, wherein the terminal device comprises at least one antenna panel (Panel), and the target information comprises at least one of the following:
measurement information of channel state information (CSI) of the at least one Panel;
measurement information of a beam management of the at least one Panel; or
change information of an antenna use state of the at least one Panel.

3. The method according to claim 2, wherein each Panel in the terminal device corresponds to at least one SRS resource set, and each of the SRS resource sets comprises at least one SRS resource.

4. The method according to claim 3, wherein the SRS resource configuration update information comprises one or more of the following:
an activation state of an expected SRS resource set on a target Panel;
an activation state of a target SRS resource in the expected SRS resource set on the target Panel.

5. The method according to claim 4, wherein the target Panel is one of the following:
all Panels on the terminal device;
a Panel on the terminal device that has a channel state change meeting the SRS resource adjustment condition;
a specific Panel on the terminal device.

6. The method according to claim 4, wherein the target SRS resource is all SRS resources or a specific SRS resource in a corresponding SRS resource set.

7. The method according to any one of claims 1-6, wherein the SRS resource configuration update information expected by the terminal device is carried by a radio resource control (RRC) signaling, a media access control-control element (MAC-CE) signaling, or uplink control information (UCI).

8. The method according to claim 2, wherein the SRS resource configuration update information comprises one of following items:
a first Bitmap, wherein the SRS resource configuration update information of each Panel is independently indicated in the first Bitmap, and the SRS configuration update information of a plurality of Panels are indicated sequentially;
a second Bitmap, wherein the SRS resource configuration update information of all Panels is jointly indicated through the second Bitmap;
a first Codepoint, wherein the first Codepoint indicates the SRS resource configuration update information of each Panel correspondingly and independently, and indicates the SRS configuration update information of a plurality of Panels sequentially;
a second Codepoint, wherein the SRS resource configuration update information of all Panels is jointly indicated through the second Codepoint.

9. The method according to claim 1, further comprising:
sending one or more of an ID of an SRS resource set and an ID of a target Panel to the network-side device.

10. The method according to claim 7, wherein in response to that the SRS resource configuration update information expected by the terminal device is carried by the UCI signaling, the method comprises one of the following:
sending the SRS resource configuration update information through a channel state information (CSI) report quantity;
reporting through a periodic CSI configuration measurement;
reporting through a semi-static CSI configuration measurement;
reporting through an aperiodic CSI configuration measurement.

11. The method according to any one of claims 1-10, wherein the SRS resource is used for codebook transmission or non-codebook transmission, and the SRS resource is one of the following:
a periodic P-SRS resource;
a semi-static SP-SRS resource;
an aperiodic AP-SRS resource.

12. A method for adjusting a sounding reference signal (SRS) resource, applied to a network-side device, wherein the method comprises:
receiving SRS resource configuration update information expected by a terminal device sent by the terminal device; and
adjusting an SRS resource configuration corresponding to the terminal device according to the SRS resource configuration update information expected by the terminal device.

13. The method according to claim 12, wherein the terminal device comprises at least one antenna panel (Panel), each antenna panel (Panel) in the terminal device corresponds to at least one SRS resource set, and each of the SRS resource sets comprises at least one SRS resource.

14. The method according to claim 13, wherein the SRS resource configuration update information comprises one or more of the following:
an activation state of an expected SRS resource set on a target Panel;
an activation state of a target SRS resource in the expected SRS resource set on the target Panel.

15. The method according to claim 14, wherein the target Panel is one of the following:
all Panels on the terminal device;
a Panel on the terminal device that has a channel state change meeting an SRS resource adjustment condition;
a specific Panel on the terminal device.

16. The method according to claim 14, wherein the target SRS resource is all SRS resources or a specific SRS resource in a corresponding SRS resource set.

17. The method according to any one of claims 12-16, wherein the SRS resource configuration update information is carried by a radio resource control (RRC) signaling, a media access control-control element (MAC-CE) signaling or uplink control information (UCI).

18. The method according to claim 13, wherein the SRS resource configuration update information comprises one of following items:
a first Bitmap, wherein the SRS resource configuration update information of each Panel is independently indicated in the first Bitmap, and the SRS configuration update information of a plurality of Panels are indicated sequentially;
a second Bitmap, wherein the SRS resource configuration update information of all Panels is jointly indicated through the second Bitmap;
a first Codepoint, wherein the first Codepoint indicates the SRS resource configuration update information of each Panel correspondingly and independently, and indicates the SRS configuration update information of a plurality of Panels sequentially;
a second Codepoint, wherein the SRS resource configuration update information of all Panels is jointly indicated through the second Codepoint.

19. The method according to claim 13, further comprising:
receiving one or more of an ID of an SRS resource set and an ID of a target Panel sent by the terminal device.

20. The method according to claim 17, wherein in response to that the SRS resource configuration update information expected by the terminal device is carried by the UCI signaling, the method comprises one of the following:
receiving the SRS resource configuration update information through a channel state information (CSI) report quantity;
receiving through a periodic CSI configuration measurement;
receiving through a semi-static CSI configuration measurement;
receiving through an aperiodic CSI configuration measurement.

21. The method according to any one of claims 12-20, wherein the SRS resource is used for codebook transmission or non-codebook transmission, and the SRS resource is one of the following:
a periodic P-SRS resource;
a semi-static SP-SRS resource;
an aperiodic AP-SRS resource.

22. The method according to claim 12, wherein adjusting the SRS resource configuration corresponding to the terminal device according to the SRS resource configuration update information expected by the terminal device comprises:
generating a corresponding SRS resource indicator (SRI) according to the SRS resource configuration update information;
sending the SRI to the terminal device.

23. An apparatus for adjusting a sounding reference signal (SRS) resource, applied to a terminal device, wherein the apparatus comprises:
a determining module, configured to determine an SRS resource configuration adjustment condition according to target information; and
a sending module, configured to send SRS resource configuration update information expected by the terminal device to a network-side device.

24. An apparatus for adjusting a sounding reference signal (SRS) resource, applied to a network-side device, wherein the apparatus comprises:
a receiving module, configured to receive SRS resource configuration update information expected by a terminal device sent by the terminal device; and
an adjustment module, configured to adjust an SRS resource configuration corresponding to the terminal device according to the SRS resource configuration update information expected by the terminal device.

25. A communication apparatus, wherein the apparatus comprises a processor and a memory, a computer program is stored in the memory, and the processor executes the computer program stored in the memory, so that the apparatus performs the method according to any one of claims 1 to 11.

26. A communication apparatus, wherein the apparatus comprises a processor and a memory, a computer program is stored in the memory, and the processor executes the computer program stored in the memory, so that the apparatus performs the method according to any one of claims 12-22.

27. A computer-readable storage medium for storing instructions, wherein when the instructions are executed, the method according to any one of claims 1-11 is implemented.

28. A computer-readable storage medium for storing instructions, wherein when the instructions are executed, the method according to any one of claims 12-22 is implemented.
